(19) United States
(12) Patent Application Publication
(10) Pub. No.: US 2002/0161713 A1
(43) Pub. Date: Oct. 31, 2002

(54) Multimedia contents service system and a method thereof

(76) Inventor: Byeong-Seok Oh, Seoul (KR)

Correspondence Address: FOLEY AND LARDNER, SUITE 500, 3000 K STREET NW, WASHINGTON, DC, 20007, US

(21) Appl. No.: 09/980,831

(22) PCT Filed: Apr. 4, 2001
(86) PCT No.: PCT/KR01/00569

(30) Foreign Application Priority Data
Apr. 6, 2000 (KR) 2000-17970

(51) Int. Cl. H04K 1/00; H04L 9/00; G06F 17/60

(52) U.S. Cl. 705/52

(57) ABSTRACT

To provide a multimedia contents at a lower price or for free, the present invention provides a multimedia contents service system from which an audience can select at least one multimedia content through communication network comprising: a memory for storing at least one of multimedia contents and advertisement contents; a contents price control unit for decreasing a price or prices of the selected multimedia contents in case the audience allow the advertisement contents to be played together with the selected multimedia contents; and a contents providing unit for retrieving from the memory the selected multimedia contents and/or the advertisement contents and providing the retrieved content(s) to the audience through communication network, wherein the advertisement contents is retrieved in case the audience allows it to be played.

### TECHNICAL FIELD OF THE ART

The present invention relates to a multimedia contents providing service system and especially to a multimedia contents providing service system for providing various kinds of multimedia contents to users for free or at a low price by associating the multimedia contents.

### BACKGROUND OF THE INVENTION

Technologies about Video On Demand (“VOD”) system or Audio On Demand (“AOD”) system are well known in the art. According to the conventional VOD or AOD system, a viewer can enjoy watching or listening desired contents at a desired time by connecting to a content provider's server system, which can provide video or audio contents (simply “multimedia contents”, hereinafter), with his/her client device, such as a television set-top box or a personal computer, connected to a network and selecting at least one of the video or audio contents which can be provided by the content provider's server.

The above described conventional content provider stores multimedia contents into a storage device of a server by digitalizing the multimedia contents, and then provides the digitalized multimedia contents through a network, where a digital communication is available, in the form of a digital data stream.

According to the recent rapid development of digital data communication technology, digital data transfer rate is greatly increased, while the amount of transferred data is decreased as compression rate is increased. Therefore, it is expected so-called Multimedia Contents On Demand (“COD”) System is commercialized in the near future.

According to the above described conventional system, the content provider charges a predetermined price for each and every multimedia content provided to the users (viewers). However, the price per content of the COD system is relatively high compare to that of the broadcasting companies or cable network companies, and the competitions against them are not promising. Further, since some contents of the COD providers are bought from the broadcasting companies or cable network companies, it is impossible to lower prices of the multimedia contents.

As for one conventional solution for this problem, the COD provider inserts commercial advertisements before, after or while the selected multimedia content is provided. However, users (viewers) seem so reluctant to watch advertisements before their multimedia contents start that the effect of advertisements could be even negative. Further, advertisements played after the multimedia contents have little effect because viewers generally do not watch them. Therefore, most effective method for advertising is known to insert advertisements while each of the multimedia contents selected by the viewers (also called as “main contents”) is being played hereinafter, His method is called as “intermediate advertisement”). However, the intermediate advertisement method also has problems that viewers are so reluctant to watch them that it is legally not allowed in some countries like South Korea.

Recently, some broadcasting companies or cable network companies have started to provide some contents already broadcasted through Internet by digitalizing the contents and storing them in their own Web server. By doing this, they are expecting to raise popularity rate of those programs.

Therefore, the COD providers should provide contents of good quality to the users for free in order to compete with the broadcasting companies and/or cable network companies, so that they must have sponsors with advertisements. Thus, according to recently developed “Web-based COD” services, new types of advertisements, like banner or box advertisements, are displayed on the COD provider's Internet home pages.

However, these banner or box advertisements are not so enough effective to receive orders from advertising sponsors.

### DETAILED DESCRIPTION OF THE PRESENT INVENTION

### BRIEF DESCRIPTION OF THE PRESENT INVENTION

The present invention was made to solve the above described problems of the conventional systems or method, and it is an object of the present invention to provide multimedia contents to a user (viewer) at relatively low prices by providing advertisement contents to the user who allows the advertisement contents to be played together with the desired or selected multimedia contents, so that the effect of advertising is increased without reluctance to the advertisement contents.

It is another object of the present invention to provide predetermined incentives to a user who allows the advertisement contents to be played together with the desired or selected multimedia contents, so that the multimedia contents may be provided at a very low price or for free by receiving advertisements from sponsors. The sponsors may expect that advertising effect will increased since the user seems to have less reluctance to the advertisement contents.

In order to achieve above and other objects, the present invention provides a multimedia content providing service system for providing a multimedia content selected by a user through a communication network including: a storage device for storing at least one of multimedia contents and at least one of advertisement contents; a content price control unit for asking the user if the user will watch at least one of the advertisement contents besides at least one of the multimedia contents which the user has selected to watch, and for discounting price of the selected at least one of multimedia contents in case the user answers that the user will watch at least one of the advertisement contents; and a content providing unit for retrieving the selected at least one of multimedia contents from the storage device, retrieving at least one of the advertisement contents in case the user answers that the user will watch at least one of the advertisement contents, and providing the selected at least one of multimedia contents and/or at least one of the advertisement contents to the user through the communication network.

Further, the present invention also provides a multimedia content providing service system, instead of the content price controlling unit, including an incentive controlling unit for asking the user if the user will watch at least one of the advertisement contents besides at least one of the multimedia contents which the user has selected to watch, and for giving a predetermined incentive to the user in case the user answers that the user will watch at least one of the advertisement contents.

Further, the present invention also provides a multimedia content providing service method for providing a multimedia content selected by a user through a communication network including steps of; displaying content information on available multimedia contents; asking the user if the user will watch at least one of advertisement contents besides at least one of the available multimedia contents which the user has selected to watch; discounting price of the selected at least one of multimedia contents in case the user answers that the user will watch at least one of the advertisement contents; retrieving the selected at least one of multimedia contents from the storage device; retrieving at least one of the advertisement contents in case the user answers that the user will watch at least one of the advertisement contents; and providing the selected at least one of multimedia contents and/or at least one of the advertisement contents to the user through the communication network.

Further, the present invention also provides a multimedia content providing service method, instead of the step of discounting price of the selected at least one of multimedia contents, including a step of: giving a predetermined incentive to the user in case the user answers that the user will watch at least one of the advertisement contents.

### BRIEF DESCRIPTION OF THE DRAWINGS

FIG. 1 is a schematic block diagram of examples of devices for multimedia contents providing service according to the present invention.

FIG. 2a is a schematic block diagram of an example of a multimedia contents providing service system according to the present invention.

FIG. 2b is a schematic block diagram of another example of a multimedia contents providing service system according to the present invention.

FIG. 3 is a flow chart of an embodiment of the multimedia contents providing service method according to the present invention.

FIG. 4 is a portion of a flow chart of another embodiment of the multimedia contents providing service method according to the present invention.

FIG. 5 is a portion of a flow chart of still another embodiment of the multimedia contents providing service method according to the present invention.

FIG. 6 is a portion of a flow chart of still another embodiment of the multimedia contents providing service method according to the present invention.

FIG. 7 is a portion of a flow chart of still another embodiment of the multimedia contents providing service method according to the present invention.

### PREFERRED EMBODIMENTS

By referring to the attached drawings, preferred embodiments and operations of the present invention are described in detail.

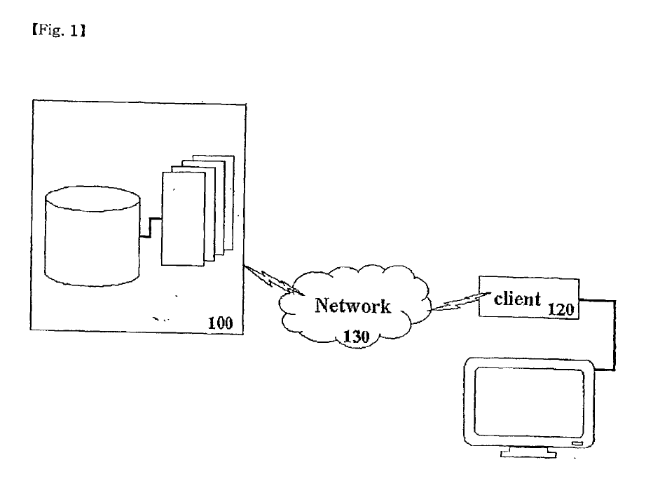

FIG. 1 is a schematic block diagram of examples of devices for a multimedia contents providing service according to the present invention. As shown in. FIG. 1, a multimedia contents providing system (simply “system”, hereinafter) 100, which functions as a server, of the present invention is connected to a communication network 130 and has communication with a client 120 which is also connected to the communication network and used by a user (viewer).

The user's client 120 may be a television with a set-top box connected to a cable network, a digital TV which has functions of receiving digital broadcasting signals and bi-directional communication or a personal computer which can connected to Internet Technologies of hardware and/or software for embodying the above described client 120 are well known to a skilled person in the art, and details are omitted.

The system (or server) 100 connected to the communication network 130 displays a list of available multimedia contents, receives user's selection and provides the selected multimedia contents to the user through the communication network 130. The system 100 includes a storage device (not shown) where digitalized multimedia contents and/or advertisement contents, which are ordered from sponsors, are stored in the form of digital data stream.

Even though it is preferable for both of the multimedia contents and the advertisement contents to be formed in a same format, an ordinary skilled person can readily recognize that the two kinds of contents may be formed in different formats. Further, the storage devices for storing these contents may be embodied in a hardware device, but it is not necessary for the hardware device to be physically single one. This is because, as described in detail below, both the multimedia contents and advertisement contents are in the form of files readable by a computer system. The only requirement of the multimedia contents and advertisement contents for the present invention is to be independently accessible by the system 100. The above described software or hardware technologies are already well known in the art, and detailed descriptions about these technologies except for those specifically related to the present invention can be omitted.

In response to the user's selection, the system 100 of the present invention asks the user if he/she would watch an advertisement content before it transfers the selected multimedia content to the user from the storage device. If the user answers that he/she will, the system 100 discounts the price of the selected multimedia content or gives an incentive when the multimedia contents are provided for free. Then, the system retrieves the selected multimedia content and the advertisement content from the storage device and transfers them to the user.

The above described multimedia content providing service of the present invention is not limited to the case where the multimedia content is played just after it is received by the client 130 of the user. Instead, the present invention can also be applicable to a case where the multimedia content is played at a desired time designated by the user after the data stream of the multimedia content is received and stored on the client 130.

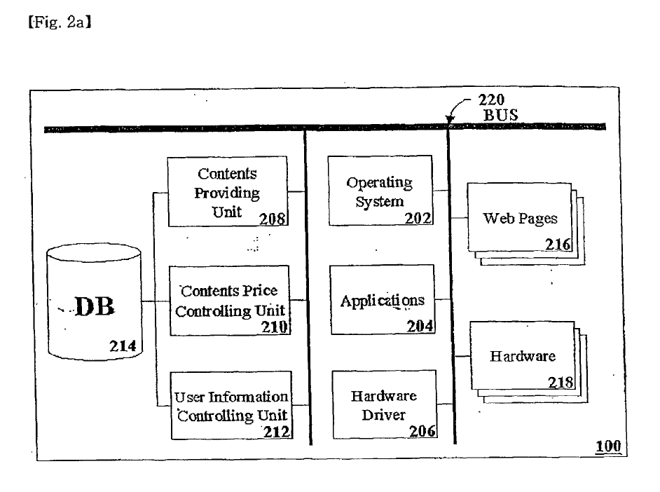

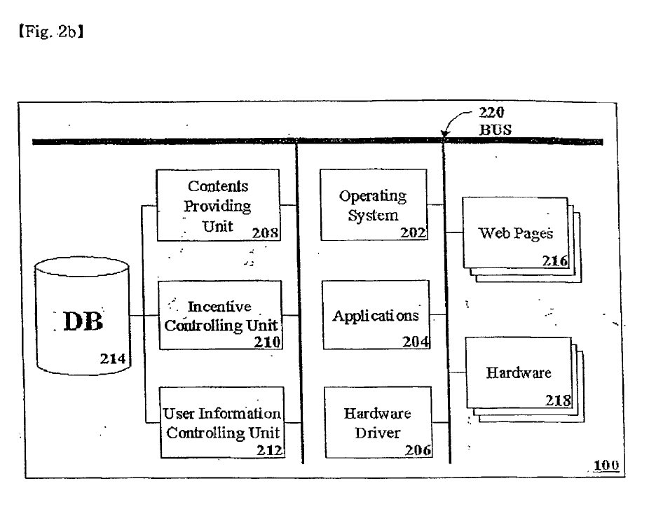

Now, referring to FIGS. 2 to 7, structure and operation of the multimedia content providing service system 100 of the present invention is described in detail.

FIG. 2a is a schematic block diagram of an example of a multimedia contents providing service system 100 according to the present invention As shown in the drawing, the system 100 includes hardware 218 like a central processing unit (not shown), a network adapter (now shown), a disc controller (not shown) and a storage device (not shown). The system 100 also includes software, such as applications of specific functions 204, hardware drivers 206 for controlling,operations of the hardware 218 an operating system (“OS”) 202 for controlling whole hardware 218 by managing the applications 204 and hardware drivers 206, and web pages 216 for providing World Wide Web (“WWW”) service to users. The above elements have communications with one another via bus 220.

The system 100 of the present invention includes a database 214 for storing and managing information on multimedia contents, advertisement contents and users. Specifically, the database 214 may store and manage content information, such as title, running time, data format, etc. The database 214 may also store and manage user information, such as name, bank account, etc.

The system 100 further includes a content providing unit 208 for providing a list of available multimedia contents to a user, allowing the user to select (a) desired multimedia content(s), retrieving the selected multimedia content(s) according to the user's selection and providing the retrieved multimedia content(s) to the user through the communication network 130.

As described later, in case the user answers that he/she will watch at least an advertisement content, the content providing unit 208 retrieves the advertisement content from the storage device and provides it to the user. The content providing unit 208 may provide a list of advertisement contents selected based on information of genre of selected multimedia contents, the time when the user wants to watch the multimedia content, the client's location, etc. to the user.

For example, if the user selects a multimedia content for infants, the content providing unit 208 may provide a list of advertisement contents showing baby products. Or, if the time when the user wants to watch the multimedia content is midnight, the content providing unit 208 may provide a list of advertisement contents showing adult products or a list of advertisement contents showing specialties of the user's location. By providing lists of advertisement contents based on above described information, it is possible to increase advertising effect.

The system 100 also includes a content price controlling unit 210 for asking the user if he/she will watch at least an advertisement content and discounting the price of the selected multimedia content when the user answers that he/she will watch the advertisement content. Especially, in case a list of more than one advertisement content is provided to the user, it is possible to further discount the price of the multimedia content according to the number of advertisement contents or playing time of the advertisement contents. This is discussed in detail, later.

The system further includes a user information controlling unit 212 for storing and managing user information such as name, bank account number, type of client device, etc. The user information controlling unit 212 may also store and manage information on preferred genre of a specific user, main connecting time band, etc.

Next, referring to FIG. 2b, another embodiment of the present invention is described in detail. FIG. 2b is a schematic block diagram of another example of a multimedia contents providing service system 100 according to the present invention. The system shown in FIG. 2b is different from that shown in FIG. 2a in that it includes an incentive controlling unit 230 instead of the content price controlling unit 210. The incentive controlling unit 230 asks the user if he/she will watch at least an advertisement content and give an incentive corresponding to the advertisement content to the user in case the user answers he/she will watch the advertisement content. Especially, in case a list of more than one advertisement content is provided to the user, it is possible to change amount or kind of the incentive, which will be given to the user, according to the number of advertisement contents or play time of the advertisement contents. This is discussed in detail, later.

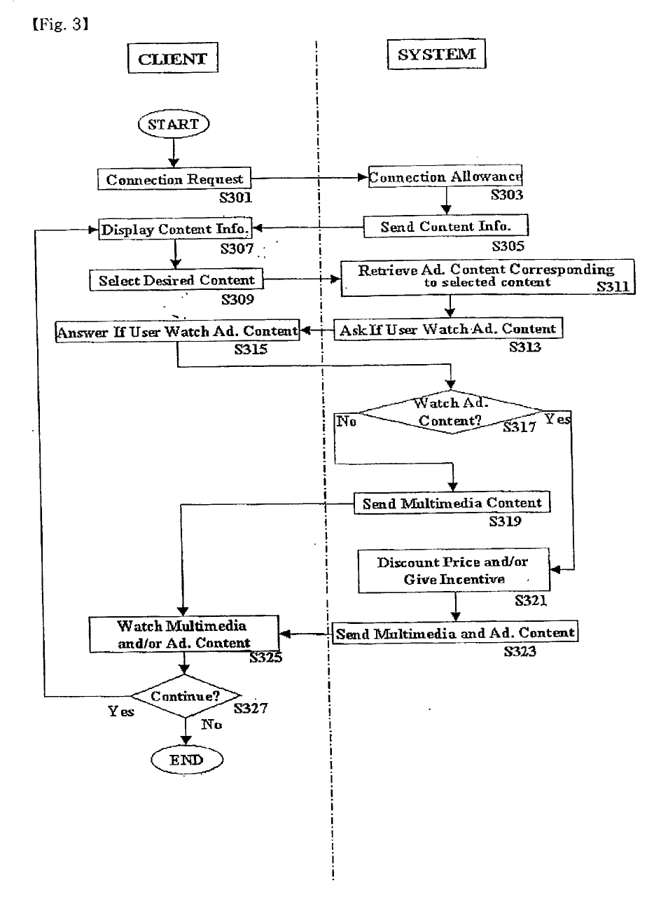

Now, referring to FIG. 3, operation of the multimedia content providing service system 100 of the present invention is described in detail. FIG. 3 is a flow chart of an embodiment of the multimedia contents providing service method according to the present invention First of all, a user tries to connect to the system 100 by using his/her client 120 through the communication network 130 (step S301).

In response to the connection request of the client 120, the system 100 may allow the client's connection as far as its service capacity is available (step S303) Here, according to the system 100 operator's preference, it is possible to require the user to perform a logging-in process using the user's ID number and password.

Then, the system 100 retrieves content information on multimedia contents stored in the storage device from the database 214 and transfers the retrieved information to the client 120 (step S305). The information may include titles, playing times and prices of available multimedia contents in the form of a list. Or, it is also preferable to provide an Internet home page which includes thumbnails of images of the multimedia contents, so that the user may easily recognize stories of the multimedia contents.

Then, the client 120 displays content information on the multimedia contents transferred from the system 100 (step S307). The client 120 may use a conventional web browser for displaying the content information from the system 100. However, if the client 120 is a television with a set-top box, it may be preferable to display only text portion of the content information, such as titles, playing times and prices of the multimedia contents.

The user selects at least one of desired multimedia contents after reading the displayed content information (step S309). Selection of the multimedia contents may be performed by clicking components like check boxes or buttons corresponding to desired multimedia contents when the client 120 uses similar user interface to that of a conventional computer system. If the client uses other user interface than that of the conventional computer system, it may be possible for the user to input serial number(s) of the desired multimedia content(s) displayed in the list of the available multimedia contents. Content information of selected multimedia contents is provided to the system 100.

The system retrieves information on the advertisement contents from the database 214 in response to the user's selection (step S311). The retrieved information on the advertisement contents may include information on all kind of advertisement contents stored in the storage device, but, as described above, it may include information on selected advertisement contents based on genre of the multimedia contents, the current time, user information, client's location, etc.

The information on advertisement contents may be formatted to be applicable to web pages like the case of content information on the multimedia contents, or to be simple texts. Further, it is also preferable to allow the user to select desired advertisement contents or to answer if he/she will watch a previously selected advertisement contents.

The system 100 lets the retrieved information on the advertisement contents be displayed to the user, and then asks the user if he/she will watch at least one of the advertisement contents (step S313). The user answers to the above inquiry of the system 100 after reading displayed information on advertisement contents (step S315).

The system determines whether or not the user will watch at least one of advertisement contents based on the user's answer (step S317). If the user answers that he/she would not watch any advertisement content, the system simply provides only the multimedia content(s) selected by the user (step S319).

However, if the user answers that he/she will watch at least one of advertisement contents, the system 100 discounts the price(s) of the multimedia content(s) selected by the user or gives corresponding incentive(s) to the user (step S321). Further, it may be also preferable for the system 100 to both discount the price(s) and give incentive(s) to the user.

Then, the system 100 provides both of the selected multimedia content(s) and advertisement content(s) to the user who answers that he/she will watch the advertisement content(s) (step S323). The user watches the provided contents (step S325).

After the user has completely watched the provided contents, the system 100 asks the user if he/she will continue to watch other multimedia content(s) (step S327). If the user answers he/she will, the system's control returns to the step S307 where content information is displayed to the user, but if the user answers he/she would not, the operation of the system 100 ends.

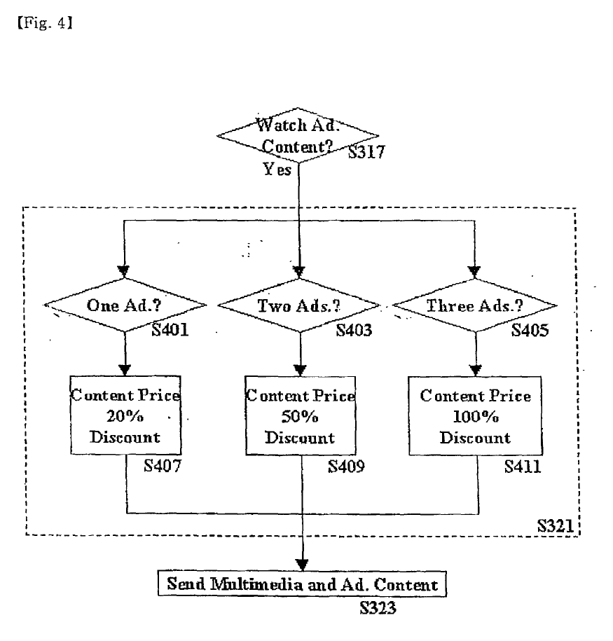

Now, referring to FIGS. 4 to 7, exemplary embodiments of the step S321 for discounting price(s) of multimedia content(s) or giving incentive(s) to the user are described in detail.

FIG. 4 is an embodiment of the step S321 shown in FIG. 3. As shown in FIG. 4, if the user answers that he/she will watch at least one of advertisement contents, the system 100 ask the user how many advertisement contents he/she will watch (steps S401, S403 or S405) Then, according to the user's answer, price(s) of the selected multimedia content(s) is discounted by, for example, 20%, 50% or 100% (steps S407, S409 or S411).

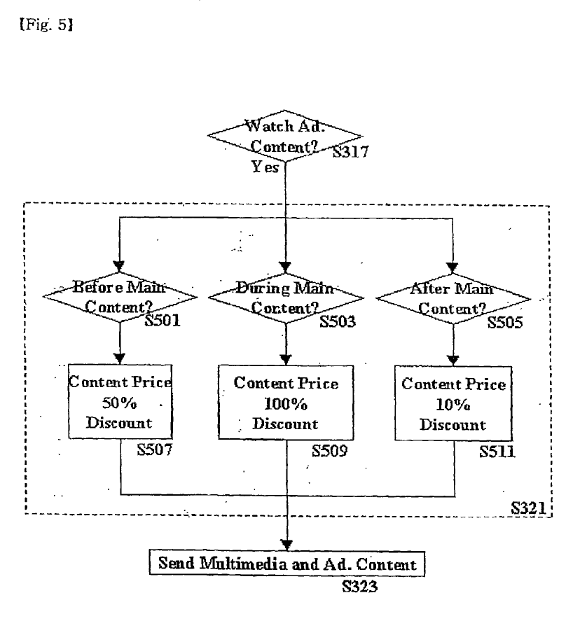

Referring to FIG. 5, FIG. 5 is another embodiment of the step S321 shown in FIG. 3, where price(s) of the multimedia content(s) varies (vary) according to the playing time of the advertisement content(s). If the user answers that he/she will watch the advertisement content(s) before the multimedia content(s) is(are) played (step S501), the system 100 discounts the price of the multimedia content(s) by, for example, 50% (step S507). Or, if the user answers that he/she will watch the advertisement content(s) while the multimedia content(s) is(are) being played (in case of intermediate advertisement) (step S503) for example, the system 100 provides the multimedia content(s) for free (step S509). Or, If the user answers that he/she will watch the advertisement content(s) after the multimedia content(s) is(are) played (step S505), the system 100 discounts the price of the multimedia content(s) by small amount, for example, 10% (step S511).

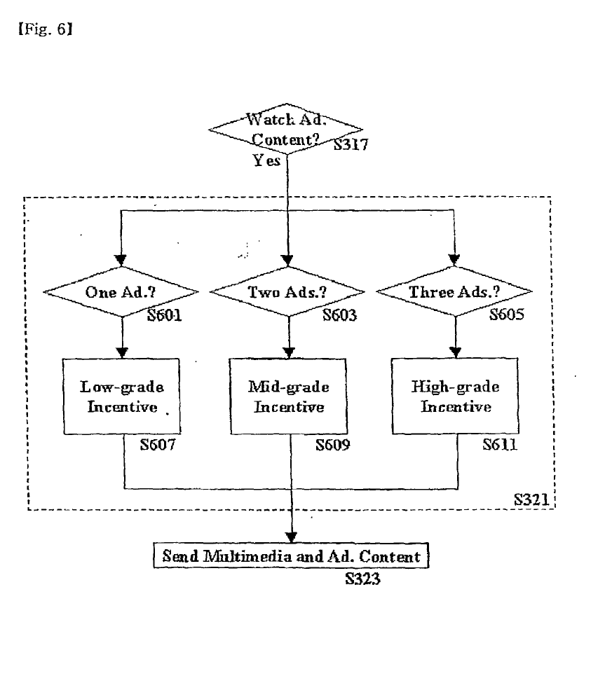

Next, referring to FIG. 6, FIG. 6 is still another embodiment of the step S321 shown in FIG. 3, where the system 100 gives predetermined type and amount of incentives to the user if the user answers he/she will watch at least one of the advertisement contents instead of discounting the price(s) of the selected multimedia content(s). For example, the system 100 asks the user how many advertisement contents he/she will watch (steps S601, S603 or S605). Then, for example, quality and/or quantity of the incentive(s) is increased in proportion to the number of advertisement contents which the user will watch (steps S607, S609 or S611). The incentive may include additional mileage points, free gifts, etc.

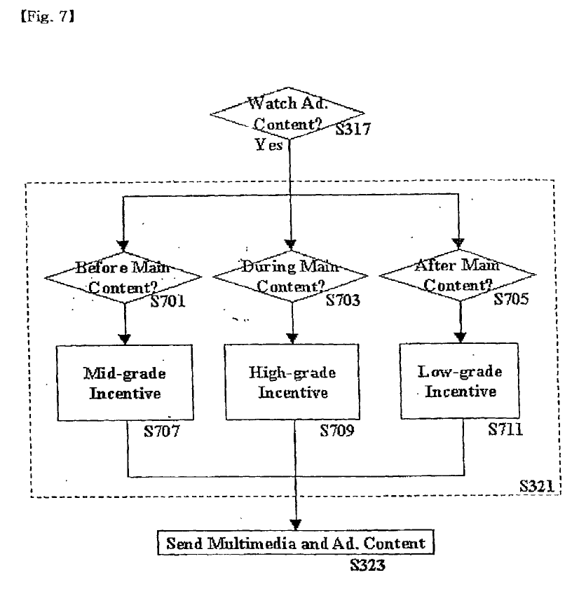

Referring to FIG. 7, FIG. 7 is another embodiment of the step S321 shown in FIG. 3, where quality and/or quantity of the incentive(s) varies (vary) according to the playing time of the advertisement content(s). If the user answers that he/she will watch the advertisement content(s) before the multimedia content(s) is(are) played (step 5701), the system 100 gives the user mid-grade incentive(s) (step S707). Or, if the user answers that he/she will watch the advertisement content(s) while the multimedia content(s) is(are) being played (in case of intermediate advertisement) (step S703), the system 100 gives the user high-grade incentive(s) (step S709). Or, If the user answers that he/she will watch the advertisement content(s) after the multimedia content(s) is(are) played (step S705), the system 100 gives the user low-grade incentive(s) (step S711).

The above embodiments for discounting price or giving incentive described wit reference to FIGS. 4 to 7 may be combined for better performances of the system 100. For example, if the user answers to watch two advertisement contents, the system 100 may both discount the price of the selected multimedia content and give a predetermined incentive to the user.

It should be noted that the above descriptions are examples of elements, operations or performances which can be embodied by the multimedia content providing service system and method of the present invention, and that the present invention is not limited to what described here. Especially, the present invention can be preferably applied to the on-demand multimedia contents providing services, but also can be applied to any type of multimedia, contents providing services only if the multimedia contents and advertisement contents provided are digitalized.

[Industrial Application]

According to the present invention, it is possible to increase effect of advertisements by providing selected multimedia contents at discounted prices or giving incentives to users who allow at least one of advertisement contents to be played.

Further, according to the present invention, it is also possible to further increase effect of advertisements by providing various kinds of advertisement contents to users under their allowances or according to their selections.

1. A multimedia content providing service system for providing a multimedia content selected by a user through a communication network comprising:
a storage device for storing at least one of multimedia contents and at least one of advertisement contents;
a content price control unit for asking said user if said user will watch at least one of said advertisement contents besides at least one of said multimedia contents which said user has selected to watch, and for discounting price of said selected at least one of multimedia contents in case said user answers that said user will watch at least one of said advertisement contents; and
a content providing unit for retrieving said selected at least one of multimedia contents from said storage devices retrieving at least one of said advertisement contents in case said user answers that said user will watch at least one of said advertisement contents, and providing said selected at least one of multimedia contents and/or at least one of said advertisement contents to said user through said communication network.

2. A multimedia content providing service system as claimed in claim 1, wherein said content price controlling unit adjusts discount rate of price of said selected at least one of multimedia contents according to the number of said advertisement contents which said user answers to watch.

3. A multimedia content providing service system as claimed in claim 1, wherein said content price controlling unit adjusts discount rate of price of said selected at least one of multimedia contents according to playing time of at least one of said advertisement contents which said user answers to watch.

4. A multimedia content providing service system as claimed in claim 1 further comprising an information communication control unit for sending and/or receiving information between said system and said user.

5. A multimedia content providing service system as claimed in claim 1, wherein said content price controlling unit for sending content information on said advertisement contents stored in said storage device in order for said user to select at least one of said advertisement contents to watch in case said user has answered that said user will watch at least one of said advertisement contents.

6. A multimedia content providing service system as claimed in any one of claims 1 to 5, instead of said content price controlling unit, comprising an incentive controlling unit for asking said user if said user will watch at least one of said advertisement contents besides at least one of said multimedia contents which said user has selected to watch, and for giving a predetermined incentive to said user in case said user answers that said user will watch at least one of said advertisement contents.

7. A multimedia content providing service system as claimed in claim 6, wherein said incentive controlling unit adjusts quality and/or quantity of said incentive according to the number of advertisement contents which said user answers to watch.

8. A multimedia content providing service system as claimed in claim 6, wherein said incentive controlling unit adjusts quality and/or quantity of said incentive according to playing time of at least one of said advertisement contents which said user answers to watch.

9. A multimedia content providing service method for providing a multimedia content selected by a user through a communication network comprising steps of:
displaying content information on available multimedia contents;
asking said user if said user will watch at least one of advertisement contents besides at least one of said available multimedia contents which said user has selected to watch;
discounting price of said selected at least one of multimedia contents in case said user answers that said user will watch at least one of said advertisement contents;
retrieving said selected at least one of multimedia contents from said storage device;
retrieving at least one of said advertisement contents in case said user answers that said user will watch at least one of said advertisement contents; and
providing said selected at least one of multimedia contents and/or at least one of said advertisement contents to said user through said communication network.

10. A multimedia content providing service method as claimed in claim 9, wherein discount rate of price of said selected at least one of multimedia contents are adjusted according to the number of said advertisement contents which said user answers to watch.

11. A multimedia content providing service method as claimed in claim 9, wherein discount rate of price of said selected at least one of multimedia contents are adjusted according to playing time of at least one of said advertisement contents which said user answers to watch.

12. A multimedia content providing service method as claimed in claim 9 further comprising a step of displaying information on said at least one of advertisement contents in order for said user to select at least one of said advertisement contents to watch in case said user has answered that said user will watch at least one of said advertisement contents.

13. A multimedia content providing service method as claimed in any one of claims 9 to 12, instead of said step of discounting price of said selected at least one of multimedia contents, comprising a step of:
giving a predetermined incentive to aid user in case said user answers that said user will watch at least one of said advertisement contents.

14. A multimedia content providing service method as claimed in claim 13, wherein quality and/or quantity of said incentive is/are adjusted according to the number of advertisement contents which said user answers to watch.

15. A multimedia content providing service method as claimed in claim 13, wherein quality and/or quantity of said incentive is/are adjusted according to playing time of at least one of said advertisement contents which said user answers to watch.
